(19) United States
(12) Patent Application Publication
(10) Pub. No.: US 2009/0295912 A1
(43) Pub. Date: Dec. 3, 2009

(54) COIN EDGE IMAGING DEVICE

(75) Inventor: Richard M. Haddock, Redwood City, CA (US)

Correspondence Address: SCHNECK & SCHNECK, P.O. BOX 2-E, SAN JOSE, CA, 95109-0005, US

(73) Assignee: COINSECURE, INC., Palo Alto, CA (US)

(21) Appl. No.: 12/463,839

(22) Filed: May 11, 2009

Related U.S. Application Data
(60) Provisional application No. 61/052,515, filed on May 12, 2008.

(51) Int. Cl. H04N 7/18; G07D 5/00; H04N 5/225

(52) U.S. Cl. 348/61; 194/330; 194/317; 348/220.1; 348/E05.024; 348/E07.085; 382/209

(57) ABSTRACT

An apparatus to record images from a coin is disclosed. The apparatus comprises a stage configured to position and rotate the coin. The stage is further configured to produce an angular positional signal output to indicate a rotational position of the coin. A first and second reflecting device are configured to concurrently image near-edge portions of both obverse and reverse sides of the coin and a recording apparatus is directed simultaneously toward an edge of the coin and the first and second reflecting devices.

### CROSS-REFERENCE TO RELATED APPLICATION

This application claims priority under 35 U.S.C. § 119(e) from prior U.S. provisional application No. 61/052,515, filed May 12, 2008.

### TECHNICAL FIELD

The present invention relates generally to coin collecting and valuation of coins, and more particularly, to an apparatus to produce optical images of coin edges both to aid in valuation, help uniquely identify a coin, and aid detection of the counterfeiting of the coins.

### BACKGROUND

The interest in the collection and conservation of coins and related objects has been historically considered a personal interest activity, with little formal standards or controls concerning the trading of coins. The recent rise in the value of coins compared to earlier levels has promoted trading of coins to a higher degree of professional structure, most significantly by the advent of commercial third party coin grading services who have developed systems to apply a widely accepted quality grade (based on a numerical scale from 1 to 70 with 70 being the highest quality). After examining and determining the grade of a coin, the commercial services place the coin in a clear plastic holder in which a grade label with a reference barcode is affixed. The clear plastic holder is then ultrasonically welded around the coin, thus permanently linking the grade to the coin within the case. A barcode is linked to the database which can be searched to confirm that the referenced coin was graded by the commercial service, along with some additional transaction details such as the date, place, person grading the coin, etc.

The grading service charges a fee for the provided services and gives a warranty of grading accuracy as part of the transaction value. The result of this commercial service is to allow the plastic encapsulated coins to be more readily traded as their trade value is directly linked to the professional quality grade on the plastic holder.

However, the current commercial grading services lack repeatability and consistency, as they are based on human opinion. Further, contemporary services are unable to prevent “grader-shopping” in which a coin owner may specifically hunt for the highest value for a given coin since there is currently not a common database or rigorous objective means for identifying a specific coin.

Perhaps more importantly, there is currently no simple and robust means to detect coin counterfeiting. Therefore, what is needed is a way to uniquely and quickly identify a particular coin that can defeat counterfeiting and confirm a coin identity.

### SUMMARY

In various exemplary embodiments, an apparatus to record images from a coin is disclosed. The apparatus comprises a stage configured to position and rotate the coin. The stage is further configured to produce an angular positional signal output to indicate a rotational position of the coin. A first and second reflecting device are configured to concurrently image near-edge portions of both obverse and reverse sides of the coin. A recording apparatus is directed simultaneously toward an edge of the coin and the first and second reflecting devices.

### BRIEF DESCRIPTION OF THE DRAWINGS

The appended drawings merely illustrate exemplary embodiments of the present invention and must not be considered as limiting its scope.

FIG. 1A is a simplified isometric drawing of an exemplary embodiment of an apparatus to concurrently provide three views on and near the edge of a coin.

FIG. 1B is a top view of the apparatus of FIG. 1A.

FIG. 1C is a cross-sectional view of the apparatus of FIG. 1A at a position as indicated in FIG. 1B.

FIG. 1D is an elevational view of the apparatus of FIG. 1A.

### DETAILED DESCRIPTION

In various exemplary embodiments disclosed herein, the value of the coin authentication and grading process is extended to include an ability to uniquely identify a specific coin by the detection and extraction of discernible coin specific features. The coin specific features are noted by concurrently recording a 360° panoramic view of both near-edge obverse and reverse features as well as the edge of the coin.

The creation of such a system solves many problems in the existing coin grading and certification business and adds value to the coin for the benefit of the coin owner. One benefit includes an ability of a party to determine if the coin has been previously seen and to review the last grade and certification reports. This can assist in minimizing grading variations in cases in which previously graded coins are broken out of the plastic holders and resubmitted for grading a second time, which is done in hopes of arbitrarily receiving a higher grade on the resubmission. It is known that this process happens today, but there is currently no means to prove a given coin is really the same one previously submitted. Having a reliable and fast means to determine if a given coin has been previously graded significantly reduces the chance of a variation in the resubmitted grading process as the reappraisal team will put in additional effort to assure an accurate result, potentially reducing warranty costs and warranty reserve requirements.

Further, a unique coin identification can reduce insurance costs by providing more absolute proof of ownership in the case of theft or loss. A permanent record of the coin ownership history can be created adding a pedigree value to the coin.

Moreover, coin owners not wanting their coins to be encapsulated in a plastic holder can have the means of having a professional grade applied to an unencapsulated coin, with a separate certificate of grade being provided, the coin and the certificate being linked by the coin ID file to assure the right coin stays associated with the grade certificate.

Due to the coin stamping process, each coin is unique, even when the coin stamping process occurs at the same mint and on the same coin-type. A single coin-type requires three stamping dies, one die each for the obverse and reverse faces of the coin and one for the edge of the coin. However, each coin has a unique stamping signature due to even slight misalignment issues between the three dies and imposed “jitter” (i.e., an unintentional variation in the stamping process caused by factors such as slight vibrational effects) while the stamping process is performed.

What is disclosed therefore is an apparatus and method for finding and recording unique permanent features of a coin that may be converted into an electronic identification file, thus allowing subsequent searchers to find and verify a specific coin. Also, the electronic identification file prevents counterfeiting of coins since each stamping signature is unique. The system comprises several components functioning together to provide an ability to analyze, capture, record, store, and retrieve a variety of physical coin characteristics that, taken together, can uniquely identify a given coin against a population of thousands to a million or more nearly identical versions of the same coin. A partial list of physical characteristics includes:
1) Surface damage of small nicks, scratches, and dings on all three coin surfaces (obverse or front side, reverse or back side, and coin edges);
2) Coin image relief height and placements;
3) Coin thickness and eccentricity;
4) Coin surface reflectivity mapped on both obverse and reverse surfaces;
5) Coin color and spectral response of both obverse and reverse surfaces;
6) Alignment and registration variations of the three surfaces in relationship to each other;
7) Variations in alloys by coin;
8) Weight of the coin; and
9) Density variations within the coin.
   These characteristics can be taken singularly or in combination to develop a recorded file, discussed in detail, below.

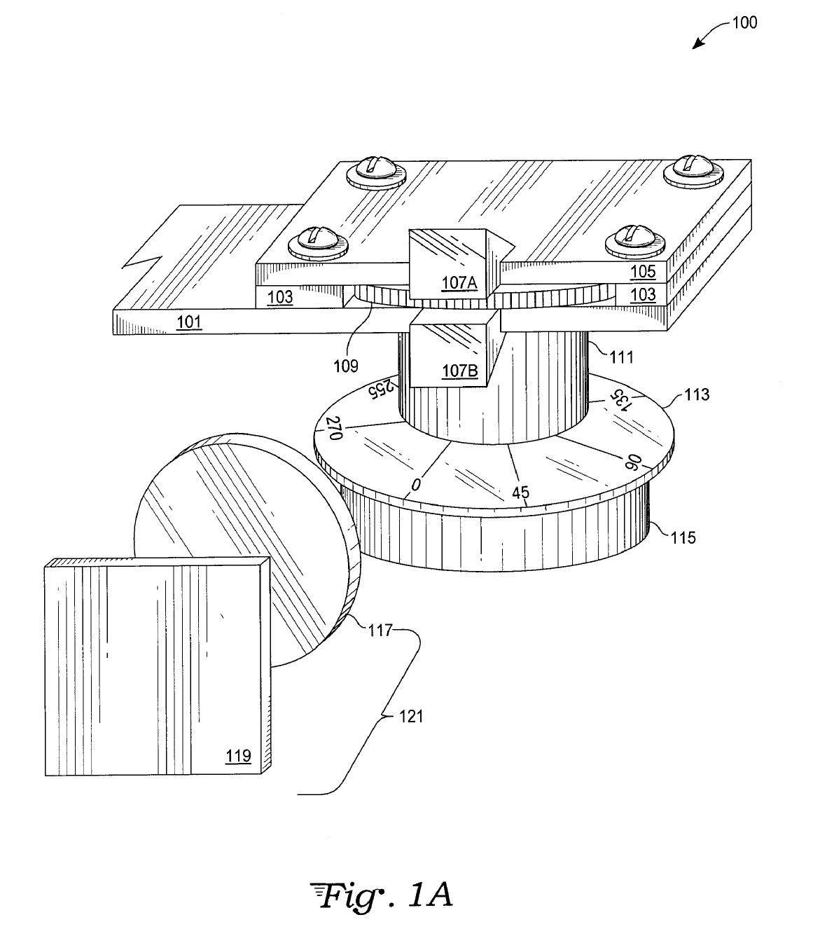

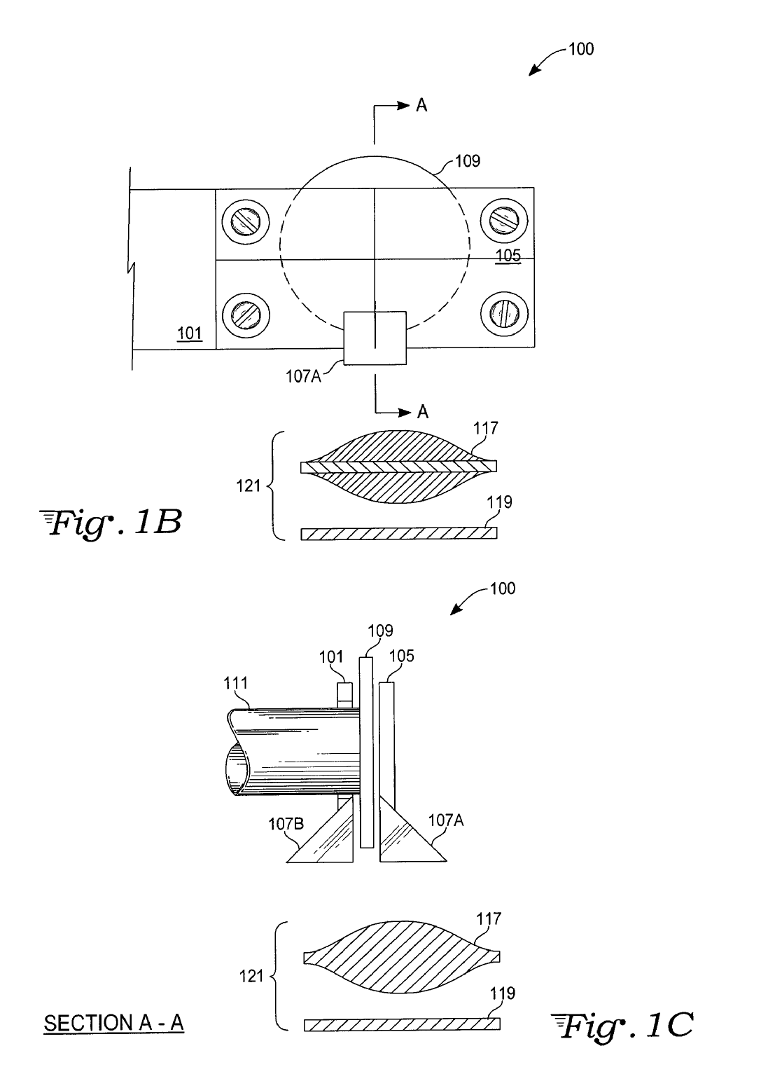

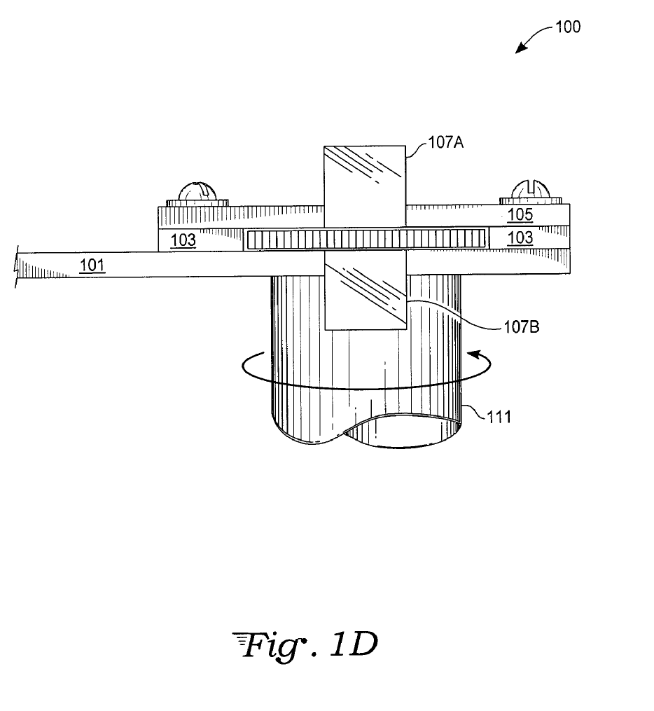

With reference now to FIG. 1A, a coin imaging apparatus 100 includes a stage comprising a support arm 101, a plurality of spacers 103, and a top plate 105. The support plate 101, plurality of spacers 103, and top plate 105 may be formed from a variety of materials including various metals and plastics. The support plate 101 may be fastened on one edge and cantilevered as shown. Alternatively, the support plate 101 may be fastened on two ends or in another way to provide support for the plurality of spacers 103 and top plate 105.

A first 107A and a second 107B prism are mounted to the top plate 105 and the support plate 101 respectively. The first prism 107A directs an image of the near-edge obverse surface of a coin 109 towards an imaging lens 117. The second prism 107B directs an image of the near-edge reverse surface of the coin 109 towards the imaging lens 117.

The coin 109 is placed or otherwise mounted on the stage between the support plate 101 and the top plate 105. The stage, in turn, is mounted atop a rotating pedestal 111 to form a kind of turntable. Means for centering the coin 109 upon the pedestal 111 are described in co-pending U.S. patent application Ser. Nos. 12/426,861 and 12/426,870, both filed Apr. 20, 2009 by the present inventor, the subject matter of which is herein incorporated by reference. An optional reference disk 113 may be employed to provide a rough indication of angular rotation of the coin 109 to a user. The coin 109 itself is indexed in the image that will be recorded by some selected design feature on the edge or near-edge obverse or reverse surface of that coin type, such as a designated numeral of a mint date stamped into the coin 109. The pedestal 111 is controlled by and coupled to a rotary encoder system 115.

The rotary encoder system 115 may be a servo or a stepper motor with, for example, an optical encoder, to provide an electronic output of a precise angular position of the coin 109. Motors and related systems for providing angular output information are known in the art.

The imaging lens 117 directs the image to a recording device 119. The imaging lens 117 may, if desired, have autofocus features. The recording device may be any type of sensor known in the art to record images such as a CCD array or CMOS sensor. The sensor may have pixels with different wavelength sensitivities, as in a tricolor sensor and could also be sensitive at one or more specified infrared (IR) and/or ultraviolet (UV) wavelengths. A combination of the imaging lens 117 and the recording device 119 is representative of an imaging system 121 such as a digital still or video camera (neither of which is shown explicitly). Instead of a single unified imaging lens 117 and recording device 119, the imaging system 121 could alternatively have three separate imaging lenses for the three coin surfaces being viewed, and likewise could have three separate sets of sensors for recording images of those three surfaces.

Any uniform and repeatable form of illumination (not shown) may be used, including, for example, a dome of LCD diffused lighting surrounding the stage for uniform omnidirectional illumination of both major surfaces and the edge of the coin, or a set of collimated unfocused laser emitters providing illumination of each surface at specified locations from specified incidence directions. If desired, the illumination may also be polarized in some specified polarization directive, in which case the imaging lens 117 and recording device 119 may have a polarization filter in front of them to provide a specified cross-polarization (e.g., 90°) relative to the illumination light. Illumination may be at multiple visible, IR and/or UV wavelengths, whether broad spectrum or at a set of designated lines, in which case the illumination color should be calibrated and controlled for repeatability.

Images from the imaging system 121 may be linked with the electronic output of the precise angular position of the coin 109, thus forming a composite record. The composite record can uniquely identify any coin thereby detecting possible coin counterfeiting as each coin edge is different as noted above.

The first 107A and second 107B prisms are arranged in relation to the edge of the coin 109 such that the imaging lens 117 concurrently views three images of the coin 109. A first image is viewed directly of the edge of the coin 109. The first 107A and second 107B prisms are arranged such that near-edge features on both the obverse and reverse sides of the coin 109 are imaged simultaneously with the edge view.

With reference to FIG. 1B, a top view of the coin imaging apparatus 100 indicates an overall relationship of the various components employed. (The reference disk 113 and the rotary encoder system 115 are not shown to preserve clarity.) A cross-sectional view A-A of FIG. 1B, as indicated by referring to FIG. 1C, provides additional detail of the first 107A and second 107B prisms in relation to the edge of the coin 109.

As will be recognizable to a skilled artisan, the area viewable by the imaging lens 117 of the obverse and reverse portions coin 109 is determined by the size and placement of the first 107A and second 107B prisms. Larger prisms may be placed so as to image larger portions of the coin 109. Additionally, the first 107A and second 107B prisms may be placed in relationship to the coin edge such that the reflected obverse and reverse sides of the coin 109 are substantially the same distance from the imaging lens 117 as is the distance from the edge of the coin 109 to the imaging lens 117, thereby mitigating any deleterious depth-of-focus problems. In another exemplary embodiment, the first 107A and second 107B prisms are replaced by front surface mirrors (not shown).

In operation, a method using the imaging apparatus 100 can uniquely identify a specific coin by building a database of identifying signatures for each coin 109 that the apparatus 100 views. Thus, the apparatus 100 obtains a set of one or more views of optically discernable individual-coin-specific features of at least a portion of one or more coin surfaces on a coin 109. More specifically, the pair of prisms 107A and 107B, the imaging lens 117 and recording device 119 obtain images concurrently from a coin edge and both obverse and reverse near-edge surfaces of the coin 109. The stage 101-105 with its rotating pedestal 111 and rotary encoder system 115 allow the images to be obtained at a set of one or more particular angular positions with respect to the edge of the coin 109 and the recorded view to be linked to the specific angular positions at which the respective views have been obtained. The set of views obtained for a given coin may comprise a complete 360° panoramic of the coin edge and obverse and reverse near-edge surfaces of that coin. As noted above, the sensors in the recording device 119 may have multiple wavelength sensitivities, so the images may be obtained and recorded over at least some portion of the visible, IR and/or UV spectrum.

The recording device 119 may record the obtained set of views for a given coin in a retrievable database as an identifying signature for that coin. As previously noted, individually-coin-specific features that are optically discernable in the views may include (1) any nicks, scratches or dings that may be present in any one or more of the observed portions of the coin surfaces, (2) various stamping signatures of the individual coins, such as coin thickness or eccentricity, relief height and placement, and variations in the alignment and registration between the edge, obverse and reverse surfaces of the coin, and (3) optically discernable features that are representative of density and alloy variations within the individual coin, namely variations in surface reflectivity and spectral response around the observed portions of the coin surfaces, dust as in a finger print or DNA sample, the stored identifying signatures of an individual coin can be accessed from the database for comparison with any coin later presented to the imaging apparatus 100. Thus, whenever a corresponding set of views are obtained from some coin, a comparison of these newly obtained set of views with the identifying signatures recorded in the database can determine whether there is a match for a previously recorded coin signature, and the degree of confidence for that match.

Referring now to FIG. 1D, a front elevational view of the coin imaging apparatus 100 indicates that a thickness of the plurality of spacers 103 is determined based upon the thickest coin that is anticipated to be used in the coin imaging apparatus 100. The thickness of the plurality of spacers is thicker than the thickest coin used in the coin imaging apparatus 100.

The present invention is described above with reference to specific embodiments thereof. It will, however, be evident to a skilled artisan that various modifications and changes can be made thereto without departing from the broader spirit and scope of the present invention as set forth in the appended claims. For example, particular embodiments describe an imaging system in the form of a digital still or video camera. A skilled artisan will recognize that other imaging systems may be employed. For example, particular applications of the coin imaging apparatus 100 may not need to record the entire visible spectrum. In certain applications, recording infra-red (IR) or ultraviolet (UV) images may be more useful to uniquely identify a coin. Further, angle-resolved light scattering or ellipsometric means may be employed to record a scattering signature with reference to an angular position of the coin. These and various other embodiments are all within a scope of the present invention. The specification and drawings are, accordingly, to be regarded in an illustrative rather than a restrictive sense.

What is claimed is:

1. An apparatus to record images from a coin, the apparatus comprising:
a stage configured to position and rotate the coin, the stage further configured to provide an angular positional signal output related to a rotational position of the coin; and
a first and second reflecting device configured to concurrently image near-edge portions of both obverse and reverse sides of the coin.

2. The apparatus of claim 1 further comprising a recording apparatus directed simultaneously toward an edge of the coin and the first and second reflecting devices.

3. The apparatus of claim 2 wherein the recording apparatus is configured to simultaneously record the angular positional signal output.

4. The apparatus of claim 2 wherein the recording apparatus is a still digital camera.

5. The apparatus of claim 2 wherein the recording apparatus is a digital video camera.

6. The apparatus of claim 1 wherein each of the reflecting devices is comprised of a prism.

7. A coin imaging apparatus to record optically discernible coin specific features for unique identification of a coin, the apparatus comprising:
a coin support plate and a top plate separated by at least one spacer, the spacer being thicker than a thickest coin expected to be placed between the coin support plate and the top plate;
a rotating pedestal attached to the coin support plate so as to provide angular rotation of the coin support plate and any coin placed between the coin support plate and the top plate;
an imaging lens for viewing an edge of any coin placed between the coin support plate and the top plate;
a pair of reflecting devices mounted on the coin support plate and top plate in a position so as to direct images of respective obverse and reverse near-edge surfaces of any coin placed between the coin support plate and the top plate towards the imaging lens; and
an image-recording device positioned relative to the imaging lens such that coin edge and respective obverse and reverse near-edge coin surfaces of any coin placed between the coin support plate and the top plate are viewable simultaneously by the image-recording device through the imaging lens.

8. The coin imaging apparatus as in claim 7, wherein the rotating pedestal is controlled by a rotary encoder system.

9. The coin imaging apparatus as in claim 8, wherein the rotary encoder system comprises a servo or stepper motor with an optical encoder, the optical encoder providing an electronic output representing a precise angular position of the coin support plate and of any coin placed between the coin support plate and the top plate.

10. The coin imaging apparatus as in claim 8, wherein images recorded by the image-recording device are linked to an angular position designated by the rotary encoder system to provide a composite record.

11. The coin imaging apparatus as in claim 10, wherein images recorded by the image-recording device comprise a concurrent 360° panoramic view of both obverse and reverse near-edge surfaces and an edge of a coin.

12. The coin imaging apparatus as in claim 7, wherein the reflecting devices comprise prisms.

13. The coin imaging apparatus as in claim 7, wherein the reflecting devices comprise front-surface mirrors.

14. The coin imaging apparatus as in claim 7, wherein the reflecting devices are positioned such that reflected obverse and reverse near-edge surfaces of a coin are substantially the same distance from the imaging lens, within a depth of focus, as is the distance from the edge of the coin.

15. The coin imaging apparatus as in claim 7, wherein the image-recording device records images in at least a portion of the visible spectrum.

16. The coin imaging apparatus as in claim 7, wherein the image-recording device records images in at least one of the infrared (IR) spectrum or the ultraviolet (UV) spectrum.

17. The coin imaging apparatus as in claim 7, further having additional imaging lenses so as to form three separate images of the respective coin edge and obverse and reverse coin surfaces.

18. A method of uniquely identifying a coin, comprising:
obtaining a set of one or more views of optically discernible individual-coin-specific features of at least a portion of one or more coin surfaces on a coin; and
recording the obtained set of views in a retrievable database as an identifying signature for that coin, such that, whenever a corresponding set of views are newly obtained from some coin, a comparison of the newly obtained set of views with identifying signatures recorded in the database determines whether views for the same individual coin have previously been obtained, and if so, then identifying that coin by its identifying signature.

19. The method as in claim 18, wherein obtaining a set of one or more views includes rotating the coin to a set of angular positions with respect to an edge of the coin, recorded views in the set being linked to the specific angular position at which the views have been respectively obtained.

20. The method as in claim 18, wherein obtaining a set of one or more views comprises obtaining images, at a set of particular angular positions, concurrently from a coin edge and from both obverse and reverse near-edge surfaces of the coin.

21. The method as in claim 20, wherein the set of one or more views forms a 360° panoramic view of the coin edge and obverse and reverse near-edge surfaces of the coin.

22. The method as in claim 18, wherein the views are obtained and recorded over at least a portion of the visible spectrum.

23. The method as in claim 22, wherein the views are also obtained and recorded over a portion of at least one of an infrared (IR) or ultraviolet (UV) spectrum.

24. The method as in claim 18, wherein the individual-coin-specific features recorded in the views as an identifying signature include the presence of any nick, scratch or ding at a location on any one or more of the coin edge and obverse and reverse near-edge surfaces of the coin.

25. The method as in claim 18, wherein the individual-coin-specific features recorded in the views as an identifying signature include a stamping signature of the individual coin comprising any one or more of coin thickness, eccentricity, image relief height and placements, and variations in alignment and registration between the edge, obverse and reverse surfaces of the coin.

26. The method as in claim 18, wherein the individual-coin-specific features recorded in the views as an identifying signature include one or more features representative of density and alloy variations within the individual coin comprising one or more of variations in surface reflectivity and spectral response around the edge, obverse and reverse near-edge surfaces of the coin.
